(19) United States
(12) Patent Application Publication
(10) Pub. No.: US 2011/0276486 A1
(43) Pub. Date: Nov. 10, 2011

(54) SYSTEM AND METHOD FOR SECURING PAYMENT

(76) Inventor: Nir KUBA, Haifa (IL)

(21) Appl. No.: 12/776,495

(22) Filed: May 10, 2010

(51) Int. Cl. G06Q 20/00; G05B 19/00; G06F 21/20

(52) U.S. Cl. 705/44; 726/4; 340/5.83

(57) ABSTRACT

A system and method for secured payment in credit transactions using a credit transaction terminal in a store, having a central processing unit adapted to communicate with the transaction terminal receiving identification information and transaction information from transaction terminal, communicating with customer to verify transaction and authenticate the identity of said customer, and carrying out a transaction without disclosing to the transaction terminal customer related information.

### BACKGROUND OF THE INVENTION

The use of credit cards as paying means has became one of the main and most popular ways of payment throughout the world. While the use of credit cards is common and very convenient both to the place of business and to the customer, it suffers from security setbacks that prevent or limit the use of credit cards in certain situations. For example, purchase orders over the phone or over the internet put both the customer and the seller in a risk that the other party would deny its involvement in the transaction and would refuse to pay or provide the goods. Another drawback of the known credit cards system is that, due to security reasons, only the owner of a credit card may use it and only when the owner has been identified will a transaction would be approved.

Another disadvantage of known credit transactions is that they require the customer to provide the seller with information that may be misused in a fraudulent manner.

The present invention is directed to overcome the above disadvantages of the known security systems for securing credit card transactions and to present a novel security system and method for securing credit transactions by authorized third parties via a mobile non-dedicated communication device such as a cellular phone, a Personal Digital Assistant (PDA), a laptop computer etc.

### SUMMARY OF THE INVENTION

A system and method for secured payment in credit transactions, using a credit transaction terminal in a store, comprising a central processing unit adapted to communicate with the transaction terminal receiving identification information and transaction information from transaction terminal, communicating with customer to verify transaction and to authenticate the identity of said customer, and carrying out a transaction without disclosing to the transaction terminal customer related information.

The system according to some embodiments of the present invention may comprise a central processing unit in active communication with at least one transaction terminal, the central processing unit comprises a central communication unit, an authentication unit, and a database wherein the central communication unit is adapted to communicate with the at least one transaction terminal and with a non dedicated mobile communication device, such as a cellular phone, of at least one customer having a credit account in said database.

According to some embodiments of the present invention the transaction terminal may comprise a transaction information input means to input transaction information, a customer's information input means to input customers identification information, a communication unit adapted to communicate with the central communication unit and to provide the transaction information and the customer's identification information to said central processing unit, wherein the authentication unit comprises an authentication information analysis unit for analyzing authentication information received from a customer and compare the authentication information with pre-obtained authentication information stored in said database.

Some embodiments of the present invention may for example provide a method for secured credit transactions comprising the steps of creating a customer credit account in a database, providing customer identification information to the transaction terminal, providing transaction information to transaction terminal, sending said identification information and said transaction information to central processing unit, identifying customer as a registered customer, authenticating the identity of the customer and executing said transaction.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a system according to one embodiment of the present invention;

FIG. 2 is a flowchart of a method of using a system for secured payment according to one embodiment of the present invention;

FIG. 3 is a flowchart of a registration process according to an embodiment of the present invention; and

FIG. 4 is a flowchart of an authentication process according to one embodiment of the present invention.

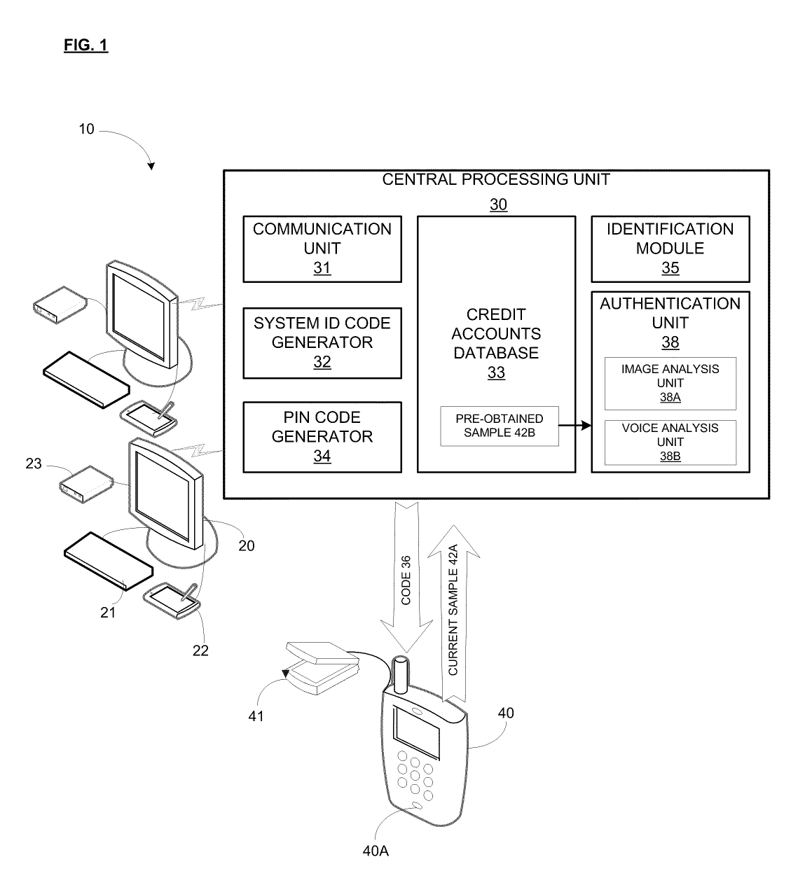

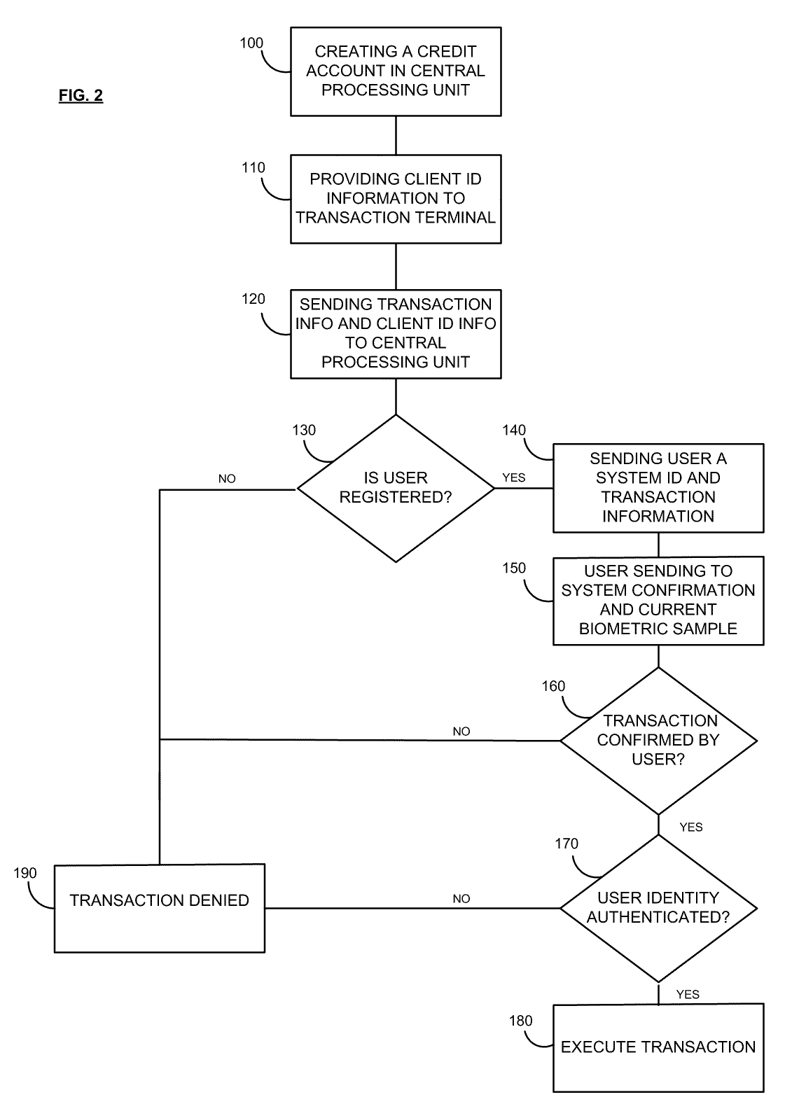

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements. The reference numerals in the description of FIGS. 2-4 refer to the structural elements in FIG. 1.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Reference is now made to FIG. 1, which is a block diagram of a secured credit transaction system 10 according to one embodiment of the present invention. As may be seen in FIG. 1, secured credit transaction system 10 may comprise a central processing unit 30 which may be in active communication with at least one transaction terminal 20. According to one embodiment of the present invention, each transaction terminal 20 may comprise a Transaction Information input means 21, such as a keypad, a keyboard or any other input means known in the art. Each transaction terminal 20 may further comprise a customer identification information input means 22 such as a magnetic card reader, an alphanumeric keypad or any other input means known in the art.

Each transaction terminal 20 may further comprise, according to some embodiments of the present invention, a communication unit 23 that may communicate with central processing unit 30. Transaction information input means 21, customer identification information input means 22 and communication unit 23 may be integrated within transaction terminal 20. However, it would be appreciated by those skilled in the art that other configurations may be used, and that one or more of transaction information input means 21, customer identification information input means 22 and communication unit 23 may be external to transaction terminal 20 and in active connection therewith.

Central processing unit 30 may comprise a central communication unit 31 adapted to communicate with at least one transaction terminal 20. Central processing unit 30 may further comprise a system identification code generator 32 and customer credit accounts database 33. System identification code generator 32 is adapted to generate a unique identification code to be associated with each customer account in customer credit accounts database 33 and to allow the customer to identify system 10 and verify that he or she is communicating with system 10. According to some embodiments of the present invention, central processing unit 30 may further comprise a Personal Identification Number (PIN) generator and database 34. PIN generator and database 34 may generate and store PIN's for all customers and may serve to authenticate the identity of a customer communicating with system 10. In alternative embodiments of the present invention, other or additional authentication information may be provided, such as a fingerprint scan, voice print or any other biometric or behavioral information that may be used in biometrical or behavioral recognition, as will be further detailed below.

When a credit transaction is required, transaction information, (e.g. price, payment terms, discounts, refunds etc.) is entered into transaction terminal 20 via transaction information input means 21. Customer identification information may also be entered to transaction terminal 20 via customer identification information input means 22. Customer identification information may be, according to some embodiments of the present invention, customer's cellular phone number, customer's identification number or any other identification information provided to central processing unit upon registration. It would be appreciated that, in order to protect the customer's secured information, customer identification information should not be the customer's PIN or other secured information, such as credit card details, bank account information etc. Transaction terminal 20 may communicate the information provided via transaction information input means 21 and customer identification information input means 22 to central processing unit 30 via communication unit 23. When transaction information is received at central processing unit 30, customer identification module 35 identifies the customer according to the customer identification information provided together with the transaction information. When a positive match is made and the customer is found in database 33, code generator 32 generates a code 36 associated with the customer account and provided to the customer upon registration, and sends the code to the customer together with the transaction information. Code 36 may be sent to the customer's non dedicated mobile communication device such as cellular phone 40. Code 36 may be sent to the customer's cellular phone 40 together with the transaction information provided by transaction terminal 20. According to some embodiments of the present invention, other or additional information may be sent to customer's non dedicated mobile communication device, such as the balance in the customer's credit account and the restrictions imposed on the account. Code 36 may be used in order to confirm to a customer that he or she are communicating with central processing unit 30 and that providing secured information is safe. Thus, eliminating the risk that customer's secured information would reach undesired entities.

When the customer receives code 36 and any other information to his non-dedicated mobile communication device, such as to cellular phone 40, he or she may then send a response. The response sent by the customer may include customer's authentication information 42A. According to one embodiment of the present invention, authentication information 42A may be a fingerprint or any other biometric authentication information captured by biometric scanner 41. Biometric scanner 41 may be an integral part of non-dedicated mobile communication device, such as cellular phone 40, or may be a separate device that may be detachably connected to the non dedicated mobile communication device 40 via a cable or via any known wireless communication protocol known in the art.

According to one embodiment of the present invention, a camera (not shown), integrated in cellular phone 40, may be used as biometric scanner 41. When authentication is required, a current sample 42A of biometric information should be provided to central processing unit 30 by the customer. The customer may obtain current sample 42A of biometric information, for instance by photographing his or her fingerprint, iris print, face etc., and send current sample 42A to authentication unit 38 at central processing unit 30. Authentication unit 38 may comprise image analysis unit 38A, to analyze the received current sample 42A. Authentication unit 38 may authenticate the identity of the customer by comparing current sample 42A of biometric information of a customer to a pre-obtained sample 42B associated with the same customer, which may be stored in database 33.

In yet another embodiment of the present invention, biometric scanner 41 may not be required, and microphone 40A embedded in cellular phone 40 may be used in order to authenticate the identity of the customer. In this instance, authentication unit 38 may comprise voice analysis unit 38B allowing authentication unit 38 in central processing unit 30 to authenticate the identity of a customer, applying voice recognition algorithms on a current sample 42A being a voice print obtained, for example, via microphone 40A and a pre-obtained sample 42B being a voice print obtained, for example, during registration or enrollment phase, stored in database 33 and associated with the customer.

It would be appreciated by those skilled in the art, as illustrated in FIG. 1, that both biometric identification and voice recognition may be used in combination in order to improve the certainty of authentication. Alternatively, more than one image, such as an iris image and a fingerprint image, may be required in order to authenticate the identity of a customer. In yet another embodiment a PIN code and biometric or behavioral information may be required in combination in order to authenticate the identity of the customer.

In yet another embodiment of the present invention, biometric scanner 41 may be a detachable device dedicated for biometrical or behavioral recognition, such as a portable fingerprint scanner 41. Other or additional detachable biometric scanners may be used.

When central processing unit 30 authenticates the identity of the customer, and the customer approves the transaction details by sending a confirmation communication to central processing unit 30, central processing unit 30 sends a transaction confirmation to transaction terminal 20 and debits the customer account in accordance with the transaction terms.

It would be appreciated by those skilled in the art that a single credit account may have one or more sub-accounts associated with one or more authorized users. Each sub-account may be associated with a different non dedicated mobile communication device and have a different system identification code 36, thus allowing several authorized users to debit a single customer credit account without being in possession of a credit card associated with said credit account. Furthermore, it would be appreciated that different sub-accounts of different users authorized to use a single credit account may have different limitations and restrictions on the use of the account. For instance, one sub-account may be limited to a single transaction a day, or to a maximum sum per transaction or a combination thereof. Other sub-accounts may be limited to certain types of transactions and/or to a certain predetermined list of stores or places of business. For instance, according to one embodiment of the present invention, an employer may provide to his employees sub-accounts to his credit account and may limit each sub-account in accordance with the job title and seniority of the employee, so that for instance employees who are required to spend time on the road, such as salesmen, may use the sub-account to purchase food and fuel in a certain predetermined chain of gas stations and convenient stores. Senior employees may be allowed to use their sub-account in a less limited manner and may have an expense limit for a week or a month. It would be appreciated by those skilled in the art that an ad hoc sub account may be created by the customer for a single transaction, a predetermined number of transactions, for a limited time period etc.

According to some embodiment of the present invention, the communication between a customer and system 10 may be via a dedicated software application that may be downloaded to the customer's non-dedicated mobile communication device upon enrollment or registration. The application may support secured communication channel allowing encrypted communication between system 10 and the customer. According to some embodiments of the present invention, when central communication unit 31 receives information from a transaction terminal, central communication unit 31 may communicate with the application installed on customer's non dedicated communication device such as cellular phone 40. When communication unit 31 identifies that the application is installed on the customer's communication device, the application may be activated and a user interface may open on the customer's non dedicated communication device display. According to one embodiment of the present invention, the customer may be required to enter a user name and password in order to further communicate with central communication unit 31 and in order to progress with confirming the transaction. It would be appreciated by those skilled in the art that other communication methods and protocols may be used for the establishment of a secured communication channel and provide authentication/confirmation means.

Reference is now made to FIG. 2, which is a flowchart of a method of using a system for secured payment according to one embodiment of the present invention, the method may comprise the following steps:

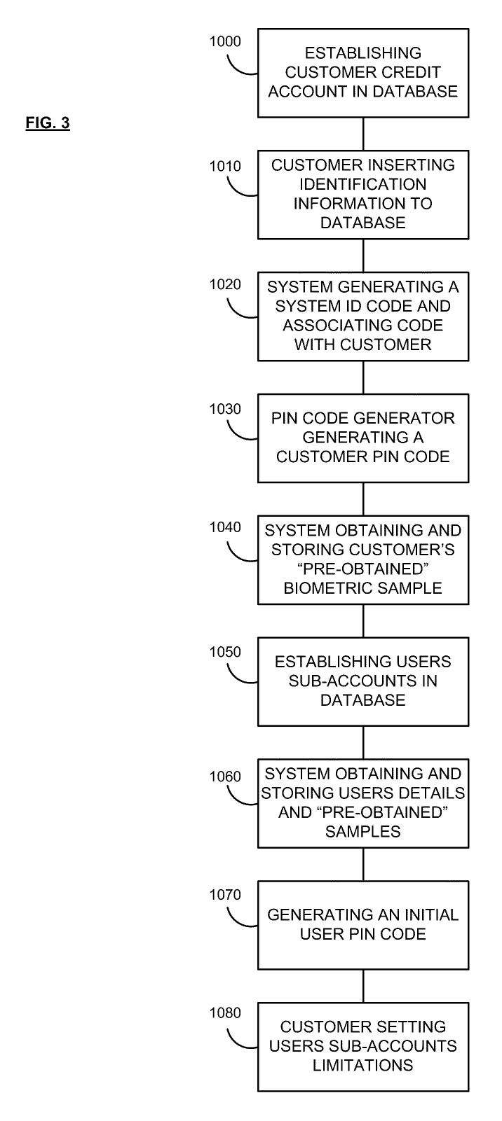

Creating a credit account [block 100]. The process of registration in which a credit account is created is further detailed with reference to FIG. 3 below.

After a customer account has been established in central processing unit 30 (in FIG. 1), the customer and/or any user having a sub account in customer account may start using the system for making secured credit transactions.

When a secured credit transaction is desired, the customer or any authorized user (both will be referred to as “client”) may provide identification information to transaction terminal 20 [block 110].

The transaction information may also be inputted into transaction terminal 20 and sent together with client's identification information to central processing unit 30 [block 120]. It would be appreciated by those skilled in the art that the client's identification information may include: full name, address, identification number (e.g., passport number), cellular phone number, or any additional or alternative information that may identify the client and that was provided to central processing unit 30 during registration.

When central processing unit 30 receives information from transaction terminal 20 in a certain place of business, identification module 35 in central processing unit 30 may extract the identification information and compare it to the information stored in database [block 130].

When the identification information received by the central processing unit does not match any registered client, the transaction may be denied [block 190]. However, when the client information matches the information stored in database, central processing unit may send a message to client's personal non dedicated mobile communication device, such as cellular phone 40. According to one embodiment of the present invention, the massage may include a system identification code generated by code generator 32 and the transaction information provided by transaction terminal 20 [block 140]. It would be appreciated by those skilled in the art that the massage sent by central processing unit 30 may be sent as a Short Massage Service (SMS), Multimedia Massaging Service (MMS), Electronic Mail (email), by a dedicated software application or any other communication protocols known in the art.

When the client receives a massage to his personal non-dedicated mobile communication device, he may check whether the massage has been sent from central processing unit 30 by checking the system identification code 36 provided with the massage. If the system identification code 36 is correct, the client may be confident that he or she is communicating with central processing unit 30. Thus, the client may reply to the massage with a confirmation of the transaction and with authentication information 42 such as a fingerprint photo [block 150].

According to yet another embodiment of the present invention, the communication between a customer and system 10 may be via a dedicated software application that may be downloaded and installed on customer's non-dedicated mobile communication device upon enrollment or registration. The application may support a secured communication channel allowing encrypted communication between system 10 and the customer. According to some embodiments of the present invention, when central communication unit 31 receives information from a transaction terminal, central communication unit 31 may communicate with the application installed on customer's non dedicated communication device such as cellular phone 40. When communication unit 31 identifies that the application is installed on the customer's communication device, the application may be activated and a user interface may open on the customer's non dedicated communication device display. According to one embodiment of the present invention, the customer may be required to enter a user name and password in order to further communicate with central communication unit 31 and in order to progress with confirming the transaction. It would be appreciated by those skilled in the art that, when an application is installed on the customer's non-dedicated mobile communication device, the need for system identification code sent to the customer in order to identify to the customer that he or she is communicating with system 10 may be obviated, as the application installed on the customers communication device communicates with a certain Internet Protocol (IP) address which indicates the particular system with which the customer communicates.

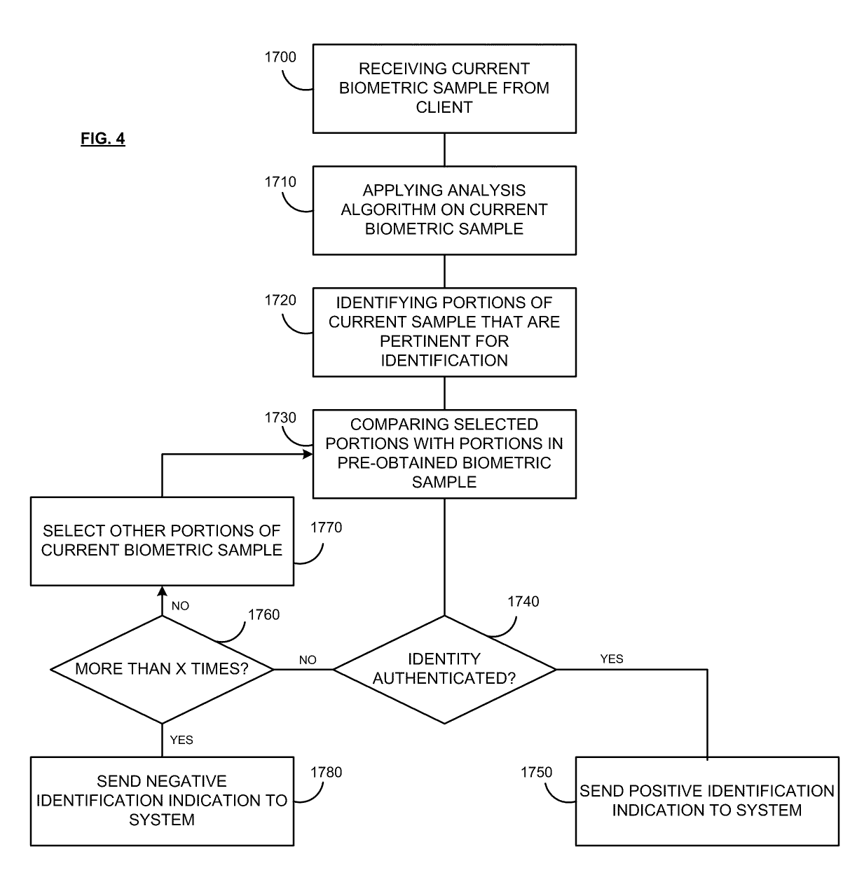

When the central processing unit 30 receives the client's reply, it may check whether the client confirmed the transaction [block 160]. If the client rejected the transaction, the transaction may be denied [block 190]. When the client confirms the transaction, central processing unit 30 may apply authentication algorithms on the authentication information sent by client [block 170]. The authentication process will be further detailed with reference to FIG. 4. If the authentication process results in the authentication of the client's identity, the transaction may be executed [block 180], the client's account is debited and the place of business is credited in accordance with the terms of the transaction. If, however, the authentication process results in a negative identification, the transaction may be denied [block 190].

According to some embodiments of the present invention, system 10 may verify when authentication information 42 was obtained (e.g., checking the time and date the fingerprint photo has been taken, checking when the voice print has been acquired, etc.). If, for instance, the fingerprint has been scanned more than a predetermined time period prior to the transaction request was sent, the transaction may be denied.

Reference is now made to FIG. 3, which is a flowchart of a registration process according to an embodiment of the present invention. According to one embodiment of the present invention, the registration may be done only on a secured terminal at a bank, a credit card company or any other secured location. Alternatively, registration may take place over a secured web page from any Personal Computer connected to the Internet.

The method of registration, according to one embodiment of the present invention, may comprise the following steps:

Establishing a customer credit account at credit accounts database 33 in central processing unit 30 [block 1000]

Inserting customer identification information and storing said information in database 33 [block 1010] and associating the identification information obtained with the credit account of the customer. The information received from the customer may include any and all of the following information: full name, address, credit card information, bank account information, home telephone number, business phone number, cellular phone number, identification number (such as passport number), and any other identification information.

Generating a system identification code 36 and associating system identification code 36 with customer credit account [block 1020]. The system identification code may be an alphanumeric code or any other code that may be send via the internet or a cellular communication network, and received by a non dedicated mobile communication device such as a cellular phone 40, a PDA, a laptop computer, a notebook computer or any other non dedicated communication device known in the art. The system identification code 36 may be a unique code that may identify the system when communicating with the customer.

According to one embodiment of the present invention, PIN code generator 34 in central processing unit 30 may further generate a PIN code to the customer [block 1030]. The PIN code may authenticate the identity of the customer when the customer communicates with the system. According to one embodiment of the present invention the PIN code generated by PIN code generator 34 may be changed by the customer to any other PIN code that meets the security requirements of system 10.

After a customer credit account has been created in the system, customer's authentication information may be obtained and associated with the credit account of the customer [block 1040]. According to embodiments of the present invention, authentication information may include all or some of the following information: fingerprints, voice signature pattern, iris prints and any other identity authentication information. According to an embodiment of the present invention, authentication information may be obtained via a biometric scanner, a camera, a microphone or any other capturing device capable of obtaining authentication information as known in the art.

The process of registration above may further allow creating sub-accounts, associated with the customer's credit account. Thus the process may further comprise the following steps:

Establishing one or more user sub-accounts, for the use of users authorized by the customer [block 1050];

Obtaining users details and authentication information [block 1060];

Generating a user PIN code [block 1070]. The user's PIN code may be different from the PIN code provided to the customer;

Setting the limitations and restrictions for each sub-account [block 1080].

It would be appreciated by those skilled in the art that the order of the above steps may be changed without affecting the results of the process.

Reference is now made to FIG. 4, which is a flowchart of an authentication process according to one embodiment of the present invention, the process comprising the following steps:

Receiving current biometric sample 42A from user, by authentication unit 38 of central processing unit 30, via a non dedicated mobile communication device, such as cellular phone 40 [block 1700].

Applying an analysis algorithm on received current biometric sample 42A [block 1710]. The analysis of the information may be done by dedicated software, hardware or firmware or a combination thereof, according to the type of biometric sample 42A received.

Authentication unit 38 may then identify portions or segments of current sample 42A, that may be pertinent for identification [block 1720].

According to one embodiment of the present invention, authentication unit 38 may locate abnormalities or unique patterns in a photo or a voice print received from a user and compare these portions of the information received with the corresponding portions of the pre-obtained and stored samples 42B [block 1730]. For instance, when the current biometric sample 42A is a photo of a user's fingerprint, unique patterns in the received photo may be identified by image analysis unit 38B in authentication unit 38 and may be compared to the pattern of the pre-obtained fingerprint of the user in the locations corresponding to the locations of the unique patterns in the received photo.

When the result of the comparison is that the similarity between the selected segments of the current sample 42A and the pre-obtained sample 42B is beyond a predetermined threshold, a positive identification indication is sent to central processing unit [blocks 1740 and 1750]. However, when the predetermined threshold is not met, another portion of the current sample 42A may be selected and compared to the corresponding portion of the pre-obtained sample 42B [blocks 1770 and 1730].

According to some embodiments of the present invention, the process may repeat itself when the predetermined threshold is not met for a selected number of times [block 1760]. When authentication unit 38 does not reach a positive identification after repeating the process more than the selected number of times, a negative identification is concluded and a negative identification indication is sent to central processing unit 30 [block 1780].

It would be appreciated by those skilled in the art that the step of applying analysis algorithm on current sample 42A may further comprise the step of verifying that current sample 42A received in authentication unit 38 was captured by biometric scanner 41 or by any other capturing device within a predetermined time period prior to receipt of said current sample 42A at authentication unit 38. According to one embodiment of the present invention, when the current sample 42A was obtained more than a predetermined time period prior to receipt of said information at authentication unit 38, the authentication process may be cancelled. According to an embodiment of the present invention, when the authentication process is cancelled, an error notice may be sent to customer.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A system for secured credit transactions comprising a central processing unit in active communication with at least one transaction terminal,
wherein said central processing unit comprises:
a central communication unit;
an authentication unit; and
a database;
wherein said central communication unit is adapted to communicate with said at least one transaction terminal and with a non-dedicated mobile communication device of at least one customer having a credit account in said database.
wherein said transaction terminal comprises:
a transaction information input means to input transaction information;
a customer's information input means to input customers identification information;
a communication unit adapted to communicate with said central communication unit and provide said transaction information and said customer's identification information to said central processing unit; and
wherein said authentication unit comprises an authentication information analysis unit for analyzing a first authentication information received from a customer and compare said first authentication information with a second authentication information, said second authentication information is pre-obtained and stored in said database.

2. The system according to claim 1 wherein said central processing unit further comprises a system identification code generator, adapted to generate a unique system identification code to identify said system when communicating with customers.

3. The system according to claim 1 wherein said central processing unit further comprises a PIN code generator, to provide registered customers with a unique PIN code for authentication of customer's identity.

4. The system according to claim 1 wherein said first authentication information and said second authentication information are one or more of a list comprising: fingerprints, iris prints, voice sample and PIN code.

5. The system according to claim 1 wherein said customer identification information is one or more of a list comprising: full name, address, identification number, home phone number, cellular phone number and business phone number.

6. The system according to claim 1 wherein said non-dedicated mobile communication device comprises at least one biometric scanner.

7. The system according to claim 6 wherein said at least one biometric scanner is embedded in said non-dedicated mobile communication device.

8. The system of claim 7 wherein said at least one biometric scanner is selected from a group comprising: a camera, a microphone, a fingerprint scanner.

9. The system according to claim 7 wherein said at least one biometric scanner is detachably connected to said non-dedicated mobile communication device.

10. The system of claim 9 wherein said at least one biometric scanner is selected from a group comprising: a camera, a microphone and a fingerprint scanner.

11. The system of claim 1 wherein said authentication information analysis unit is an image analysis unit to analyze image authentication information received from customers.

12. The system of claim 1 wherein said authentication information analysis unit is a voice analysis unit to analyze voice authentication information received from customers.

13. The system of claim 1 wherein each of said customer's credit account comprise one or more authorized users' sub-accounts.

14. The system of claim 13 wherein each of said sub-accounts is associated with a different non dedicated mobile communication device.

15. The system of claim 14 wherein each of said sub-accounts is associated with different user identification information and different user authentication information, to authenticate the identity of said authorized user.

16. A method for secured credit transactions comprising:
creating a customer credit account in a database;
providing customer identification information to transaction terminal;
providing transaction information to transaction terminal;
sending said identification information and said transaction information to central processing unit;
identifying customer as a registered customer;
authenticating the identity of the customer; and
executing said transaction.

17. The method according to claim 16 wherein when the customer is identified as a registered customer, sending to said customer's non-dedicated mobile communication device a system identification code and said transaction information.

18. The method according to claim 17 wherein when customer confirm said transaction, sending via said non-dedicated mobile communication device, a confirmation indication and authentication information to an authentication unit in said central processing unit.

19. The method according to claim 18 wherein the step of authentication comprises the steps of:
when customer confirms transaction, analyzing said authentication information received from customer, and comparing said authentication information with pre-obtained authentication information; and
when said authentication information received from customer matches said pre-obtained authentication information, executing transaction.

20. The method of claim 19 wherein said step of analyzing said authentication information comprises the steps of:
selecting portions of said authentication information that contain unique information;
comparing said selected portions of said authentication information with corresponding portions of pre-obtained authentication information; and
when said selected portions of said authentication information and said corresponding portions of pre-obtained authentication information are substantially identical, sending a positive identification indication.

21. The method of claim 20 wherein when said selected portions of said authentication information and said corresponding portions of pre-obtained authentication information are not substantially identical, selecting other portions of said authentication information and comparing said other portions of said authentication information with corresponding portions of said pre-obtained authentication information.

22. The method of claim 21 wherein repeating said selecting step and said comparing step is limited to a predetermined number of times; and
wherein when, after said predetermined number of times, said selected portions of said authentication information and said corresponding portions of said pre-obtained authentication information are not substantially identical, sending negative identification indication.

23. The method of claim 20 wherein prior to analyzing said authentication information, verifying the time in which said authentication information has been obtained and, when said authentication information was obtained more than a predetermined time period prior to the time said authentication information was received at said authentication unit, denying the transaction.

24. The method of claim 16 further comprising the step of installing a dedicated software application on customer's non-dedicated mobile communication device after creating a customer credit account to allow customer to communicate with said central processing unit via said application in a secured communication channel.
